(19) United States
(12) Patent Application Publication
(10) Pub. No.: US 2005/0069303 A1
(43) Pub. Date: Mar. 31, 2005

(54) Hair dryers

(76) Inventors: Mario Maione, Monroe, CT (US); Richard Neil Tobin, Monroe, CT (US); John Wilcox, Newport, RI (US)

Correspondence Address: Melvin I. Stoltz, 51 Cherry Street, Milford, CT, 06460, US

(21) Appl. No.: 10/932,977

(22) Filed: Sep. 2, 2004

Related U.S. Application Data
(60) Provisional application No. 60/506,029, filed on Sep. 25, 2003.

(51) Int. Cl. A45D 20/10; F21L 2/00

(52) U.S. Cl. 392/385

(57) ABSTRACT

By incorporating ceramic materials to produce far-infrared and/or infrared radiation and impart the radiation into the heated air stream for delivery directly to the hair fibers, a hair dryer is realized which is capable of providing enhanced beneficial effects to the hair fibers in a cost effective manner. In accordance with the present invention, ceramic components or ceramic coated components are mounted in association with the heating means and/or the exit portal for delivering the desired infrared/far-infrared radiation directly to the airflow exiting the hair dryer, for delivery to the hair fibers. In one embodiment, a ceramic coated member is mounted adjacent the exit portal, positioned for enabling the heated airflow to contact the ceramic coated member and generate and/or emit far-infrared/infrared radiation, while several alternate embodiment mount the ceramic material directly with the heating member.

### RELATED DATA

This application is related to U.S. Provisional Patent Application Ser. No. 60/506,029, filed Sep. 25, 2003 entitled Hair Dryers.

### TECHNICAL FIELD

This invention relates to hair dryers and, more particularly, to improved hair dryer constructions which substantially enhance and improve the drying of the hair fibers and the conditioning of the hair fibers.

### BACKGROUND ART

Men and women have had, for many decades, the desire of drying their hair after washing. Typically, a hand-held hair dryer is employed, which is constructed for drawing ambient air through an elongated passageway in which a heat source is retained. As the air flows over the heat source, the temperature of the following air is raised, with the heated air being channeled to an exit portal where the heated air is applied to the user's wet hair fibers. By continuously exposing the wet hair fibers to the heated air stream, the desired drying effect is realized.

In order to meet the substantial demand that has been developed for hand-held hair dryers, a wide variety of styles, configurations, and product enhancements have evolved. However, in spite of the substantial effort that has been expended in developing a universally acceptable hair dryer, the industry has failed to achieve a hand-held hair dryer which is capable of satisfying all of the consumer demands imposed thereon. In this regard, one principal objection raised by many users is the inability of achieving optimum drying of one's hair in a minimum period of time, while simultaneously enhancing the physical characteristics of the hair fibers.

In attempting to satisfy these desires of most consumers, the heating elements contained in the hand-held hair dryers have been increased in order to impart higher and higher temperatures to the air flow. However, although increased temperatures have been realized, consumers have been reluctant to employ hair dryers having substantially increased air flow temperatures, due to the discomfort produced by these products. In addition, these higher temperatures are believed to potentially damage the hair fibers, without additional hair conditioning elements being incorporated into the hair dryer.

As a result, prior art products have more recently been developed which employ ceramic components or ceramic coated components formed in a hair dryer in order to provide far-infrared and/or infrared radiation in the heated airflow. It is believed that the application of far-infrared and/or infrared radiation onto the hair fibers causes a healthier scalp, while also adding luster, shine, sheen, and conditioning to the hair fibers. In addition, effects of weather conditions on the hair fibers are also believed to be reduced.

In spite of these attempts in prior art products to produce a hair dryer having these perceived beneficial results, competitively priced hair dryers have been incapable of being achieved. As a result, hair dryers having these perceived benefits have typically been substantially more expensive than conventional hair dryers, pricing such products beyond the reach of most consumers.

Consequently, it is a principal object of the present invention to provide a hair dryer which is capable of providing enhanced beneficial effects to the hair fibers in a competitively priced product.

Another object of the present invention is to provide a hair dryer having the characteristic features described above which incorporates ceramic material mounted in optimum locations for producing far-infrared and/or infrared radiation and delivering the radiation directly into the heated air flow.

Another object of the present invention is to provide a hair dryer having the characteristic features described above which enables ceramic material to be quickly and easily mounted in the hair dryer in a cost effective manner.

Other and more specific objects will in part be obvious and will in part appear hereinafter.

### SUMMARY OF THE INVENTION

By employing the present invention, many of the difficulties and draw-backs found in prior art hair dryers have been overcome and a hair dryer is realized which is capable of providing enhanced beneficial effects to the hair fibers in a cost effective manner. In accordance with the present invention, several unique constructions are achieved which enable the incorporation of ceramic material directly in the body of the hair dryer, in a position which allows the ceramic materials to produce far-infrared and/or infrared radiation and impart the radiation into the heated air stream for delivery directly to the hair fibers. Furthermore, the unique structural elements employed for achieving the securement and mounting of the ceramic materials in the hair dryer is achieved in a cost efficient manner.

In accordance with the present invention, a generally conventional hair dryer construction is employed incorporating an elongated tubular shaped body having an entry portal, an exit portal, and a motor driven fan for drawing air into and forcing air through the tubular shape body. In addition, the hair dryer incorporates air heating means, preferably constructed in the form of heating coils, which are wrapped about a support member and are positioned for enabling the air to flow around the heating coils, raising the temperature of the air prior to be delivered to the exit portal.

In accordance with the present invention, in order to deliver the desired far-infrared and/or infrared radiation into the heated airflow, ceramic components or ceramic coated components are mounted in association with the heating means and/or the exit portal for delivering the desired infrared/far-infrared radiation directly to the airflow exiting the hair dryer, for delivery to the hair fibers. In one embodiment, a ceramic coated member is mounted adjacent the exit portal, positioned for enabling the heated airflow to contact the ceramic coated member and generate and/or emit far-infrared/infrared radiation, which is then carried away in the heated airflow and delivered directly to the hair fibers.

In this embodiment, the ceramic coated member may comprise various desired or convenient sizes or shapes which enables the ceramic coated member to be easily mounted and securely maintained in association with the exit portal of the hair dryer. Although many desired configuration can be employed, it has been found that a substantially circular shaped ring member is easily manufactured and conveniently mounted in the desired location.

In an alternate embodiment of the present invention, ceramic component are constructed for being mounted in direct association with the heating coils, thereby enabling the far infrared/infrared radiation to be generated and delivered directly into the heated airflow. In order to attain a cost efficient construction, it has been found that the ceramic material preferably comprises a configuration consisting of one or more selected from the group consisting of beads, rods, cylinders and tubes.

By constructing the ceramic material in a size and shape which enables the mounting of the ceramic component in direct association with the heating coil of the hair dryer, an easily manufactured, cost efficient, highly effective construction is attained. In this way, a hair dryer configuration is achieved which is capable of satisfying many of the long felt needs and desires of consumers.

In addition, if desired, the ceramic components and the ceramic coated components detailed herein may be combined in a single hair dryer. In this way, a multiple source for the far-infrared/infrared radiation is provided, with the enhanced beneficial results being optimized.

The invention accordingly comprises a product possessing the features, properties, and relation of component which will be exemplified in the product hereinafter described, and the scope of the invention will be indicated in the claims.

### THE DRAWINGS

For a fuller understanding of the nature and objects of the invention, reference should be had to the following detailed description taken in connection with the accompanying drawings, in which:

FIG. 1 is a side elevation view of a hair dryer constructed in accordance with the present invention;

FIG. 2 is a cross-sectional side elevation view of the hair dryer of FIG. 1;

FIG. 3 is a top plan view, partially broken away, of the heating unit employed in the hair dryer of FIG. 1, incorporating one embodiment of the ceramic elements of the present invention;

FIG. 4 is a front elevation view of the heating unit of FIG. 3 and the ceramic elements incorporated therein;

FIG. 5 is a greatly enlarged end view of one of the ceramic elements of FIGS. 3 and 4;

FIG. 6 is a side elevation view of the ceramic element of FIG. 5;

FIG. 7 is a front elevation view of a heating unit employed in the hair dryer of the present invention incorporating an alternate embodiment of the ceramic elements of the present invention;

FIG. 8 is a front elevation view of a heating unit employed in the hair dryer of the present invention incorporating a further alternate embodiment of the ceramic elements of the present invention;

FIG. 9 is a perspective view, partially broken away, of a hair dryer incorporating a still further alternate embodiment of the ceramic elements of the present invention;

FIG. 10 is a front elevation view of the hair dryer of FIG. 9;

FIG. 11 is a perspective view, partially broken away, of a hair dryer incorporating a still further alternate embodiment of the ceramic elements of the present invention;

FIG. 12 is a front elevation view of the hair dryer of FIG. 11;

FIG. 13 is a top plan view, partially broken away, of the heating unit of the hair dryer incorporating another further embodiment of the ceramic elements of the present invention;

FIG. 14 is a side elevation view of the ceramic element of FIG. 13; and

FIG. 15 is an end view of the ceramic element of FIG. 14.

### DETAILED DESCRIPTION

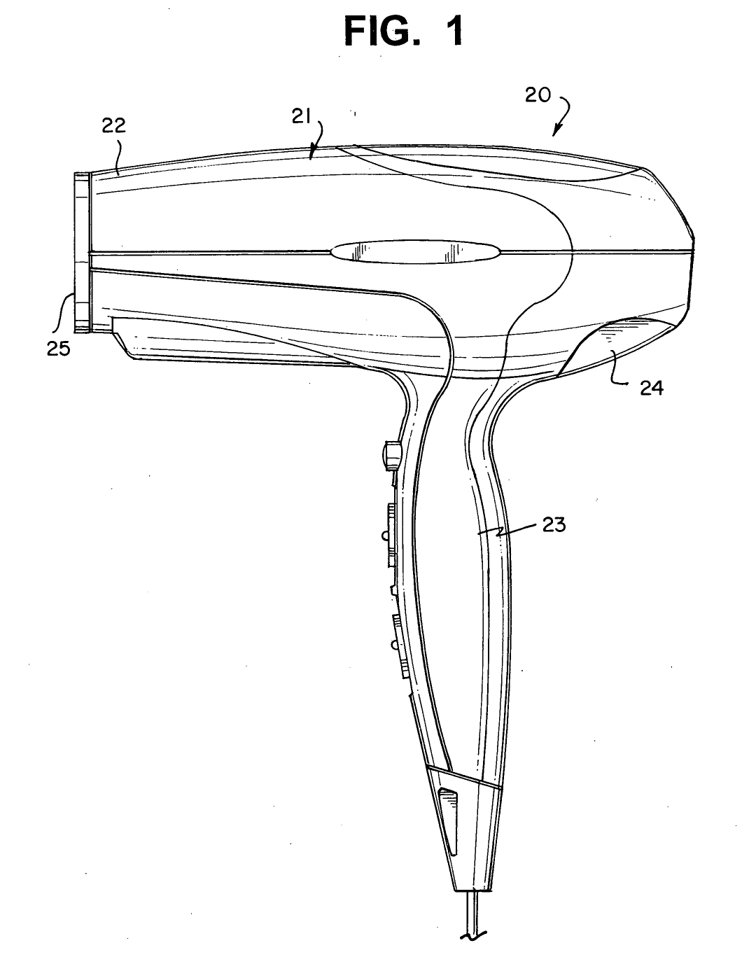

By referring to FIGS. 1-15, along with the following detailed disclosure, the construction and operation of several preferred alternate embodiments of the hair dryer system of the present invention can best be understood. Although these alternate preferred embodiments of the present invention are fully disclosed herein, further alternate constructions may be implemented without departing from the scope of this invention. Consequently, it is to be understood that this detailed disclosure is provided for exemplary purposes only and is not intended as a limitation of the present invention.

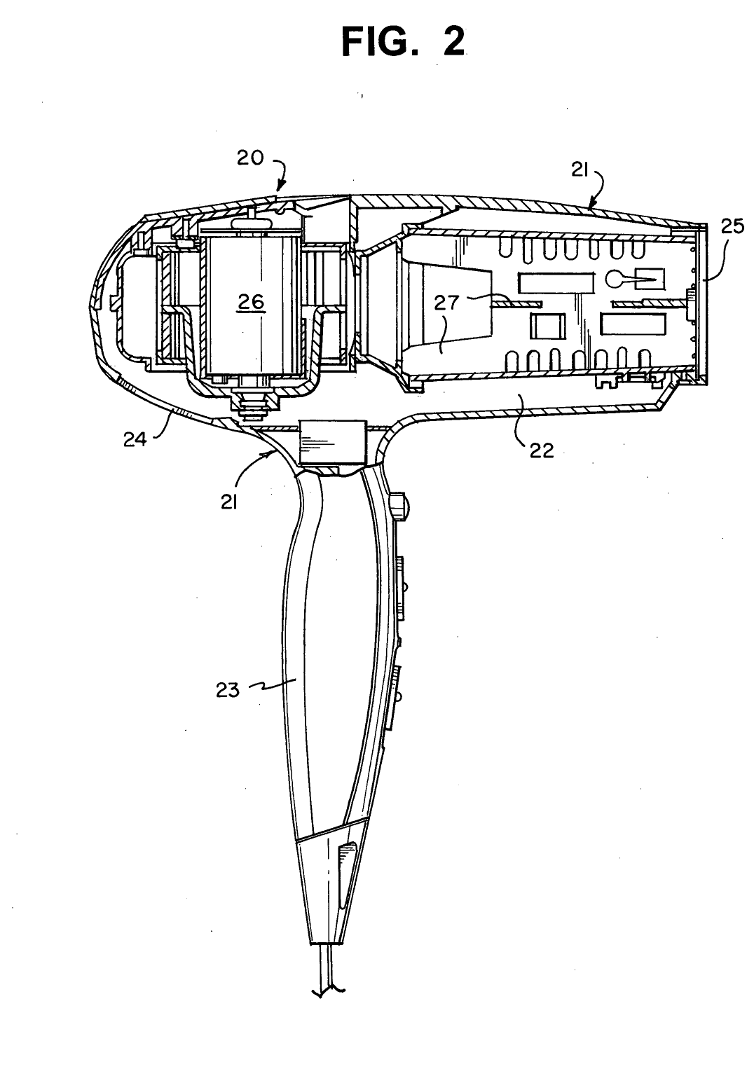

In FIGS. 1-6, one preferred embodiment of the hair dryer construction of the present invention is fully depicted, with FIGS. 1 and 2 depicting a generally conventional hair dryer construction employed for all of the embodiments of this invention. In this regard, hair dryer 20 comprises housing 21 which incorporates elongated, generally cylindrical, tubular shaped body portion 22 which is connected with handle portion 23. In addition, body portion 22 incorporates inlet portal 24 and exit portal 25.

As shown in FIG. 2, the interior zone established by cylindrical, tubular shape body portion 22 incorporates motor driven fan assembly 26, which is mounted in cooperating relationship with inlet portal 24. When activated, fan/motor assembly 26 draws air into body portion 22 through inlet portal 24, while also forcing the air to flow through body portion 22 and out through exit portal 25.

In addition, longitudinally extending support plates 27 are mounted in body portion 22 between fan/motor assembly 26 and exit portal 25, with heating coil 28 wrapped about longitudinally extending support plates 27 in a generally continuous spiral configuration. In this way, the air flowing through body portion 22 flows around heating coils 28, thereby causing the temperature of the flowing air to be raised to the desired temperature. Typically, a plurality of support plates 27 are employed and are mounted to each other in an intersecting manner.

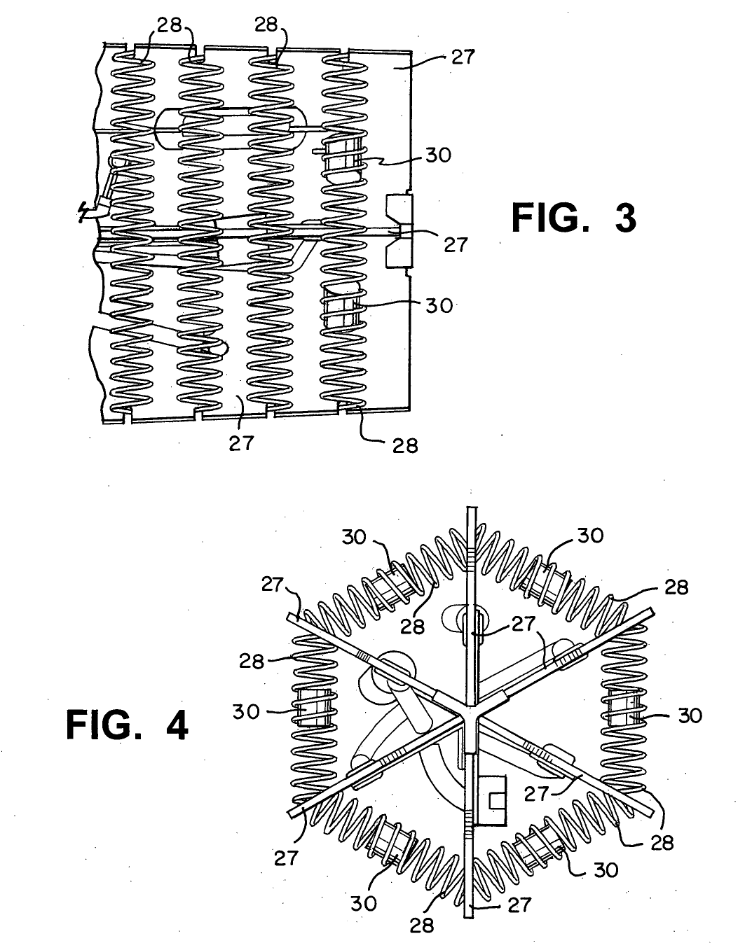

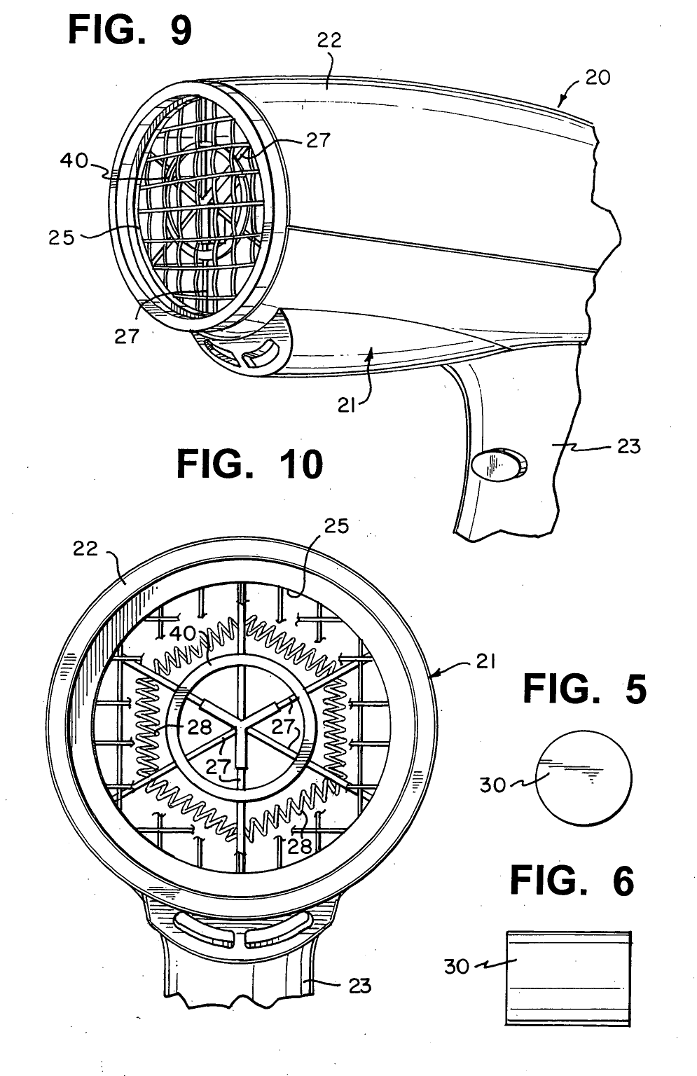

In this embodiment of the present invention, ceramic material constructed for producing and/or emitting far-infrared/infrared radiation is positioned in direct association with heating coils 28. In the embodiment shown in FIGS. 3 and 4, ceramic elements 30 are positioned within heating coil 28, peripherally surrounded in their entirety by heating coil 28. As further detailed in FIGS. 5 and 6, each ceramic element 30 comprises a spherical bead or small cylindrical construction which is dimensioned to enable ceramic elements 30 to be mounted in peripheral surrounded, cooperating engagement within heating coil 28.

As shown, heating coil 28 preferably comprises an elongated, continuous wire which has been formed in a continuous spiral construction and is wound around the outer edges formed by the length of intersecting support plats 27. As a result, ceramic element 30 can be formed and positioned within the diameter established by the spiral formed coil.

In the preferred construction of this embodiment, each ceramic element 30 comprises a spherical shape or a small cylindrical shape dimensioned for mounted engagement within heating coil 28. In the embodiment depicted in FIGS. 5 and 6, the small cylindrically shaped ceramic element 30 comprises a total length ranging between about 3.5 and 4.5 mm and diameter ranging between about 2.80 and 3.5 mm. Although preferred, any suitable configuration which enables ceramic element 30 to be mounted in secure, retained engagement within heating coil 28 can be employed with equal efficacy.

As is evident from FIG. 3, ceramic elements 30 are depicted mounted in the forwardmost coil of heating element 28. However, if desired, ceramic elements 30 can be mounted in heating coil 28 at any position along the length of longitudinally extending support plates 27, as coil 28 peripherally surrounds and extends the length thereof. Consequently, it is to be understood that the position of ceramic element 30 depicted in FIG. 3 is for illustrative purposes only and is not intended as a limitation on the position, location, or placement of ceramic element 30.

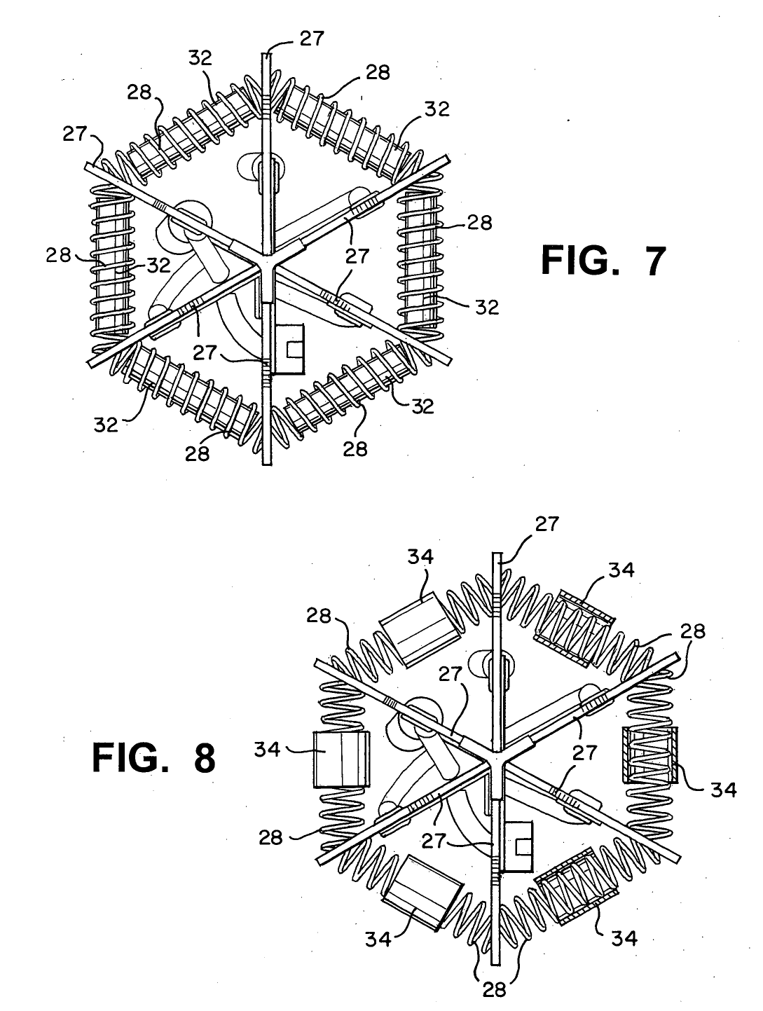

In FIG. 7, an alternate construction for the ceramic component is shown. In this embodiment, ceramic element 32 is depicted as comprising a generally elongated rod-like construction, preferably having a circular cross-section similar to ceramic element 30. However, in this embodiment, ceramic element 32 comprises an overall length substantially greater than the length of ceramic element 30. Preferably, ceramic element 32 comprises a diameter which enables ceramic element 32 to be easily positioned in peripheral surrounding supported engagement within heating coil 28, while extending therein for a length substantially greater than ceramic element 30. However, depending upon the overall length of the heating coil section within which ceramic element 32 is mounted, the overall length is incapable of realistically exceeding the segment within which ceramic element 32 is positioned.

Finally, in FIG. 8, a still further alternate embodiment for the ceramic component of the present invention is depicted. In this embodiment, ceramic element 34 comprises a hollow cylindrical or tubular shape and is mounted peripherally surrounding heating coil 28. In this embodiment, ceramic element 34 is mounted to coil 28 of hair dryer 20 during the assembly of heating coil 28 with support plates 27, with heating coil 28 being threaded through ceramic element 34, enabling ceramic element 34 to peripherally surround heating coil 28, retained thereon in secure, supported engagement therewith.

By employing this embodiment of the present invention, a plurality of ceramic elements 34 are positioned along the length of heating coil 28, securely retained in position by being supported directly on heating coil 28. In this way, each ceramic element 34 is capable of producing and/or emitting the desired far-infrared/infrared radiation and delivering the radiation directly to the flowing heated air for subsequent delivery to the hair fibers of the user.

In FIGS. 9 and 10, a further alternate embodiment of hair dryer 20 of the present invention is provided. In this embodiment, hair dryer 20 comprises housing 21 which incorporates elongated, generally cylindrical, tubular shaped body portion 22. In addition, body portion 22 incorporates an inlet portal (not shown) and an exit portal 25. Furthermore, as discussed above in detail in regard to FIGS. 1 and 2, this embodiment of hair dryer 20 is constructed and operates in a substantially identical manner, drawing air into body portion 22, heating the air, and forcing the heated air through body portion 22 for being delivered to the user.

In order to impart far-infrared/infrared radiation into the heated air being delivered to the user, this embodiment of the present invention incorporates ceramic coated ring 40, which is mounted in cooperating relationship with exit portal 25. As depicted, in this embodiment, ring 40 preferably comprises a diameter which is substantially less than the diameter of exit portal 25. In this way, ring 40 is positioned substantially midway between the central axis of exit portal 25 and its terminating edge.

In this embodiment, ring 40 is preferably formed from a lightweight, base material, such as aluminum, which is coated with a ceramic layer. In this way, the heated air flowing past ring 40 raises the temperature of ring 40 and its ceramic coating layer, causing far-infrared and infrared radiation to be generated. This radiation is then drawn into the heated air flow for delivery to the hair fibers of the user.

By employing this embodiment of the present invention, a simple, easily executed, and comparatively inexpensive construction is realized wherein ceramic material is effectively integrated into a hair dryer construction to enable far-infrared/infrared radiation to be generated by the ceramic material and imparted into the heated air flow for delivery to the hair fibers of the user. As a result, the beneficial effects attributed to far-infrared/infrared radiation is provided to consumers in a comparatively inexpensive, hair dryer construction, enabling a broad cross-section of consumers to enjoy the hair care benefits previously obtainable in only high-end, expensive hair dryers.

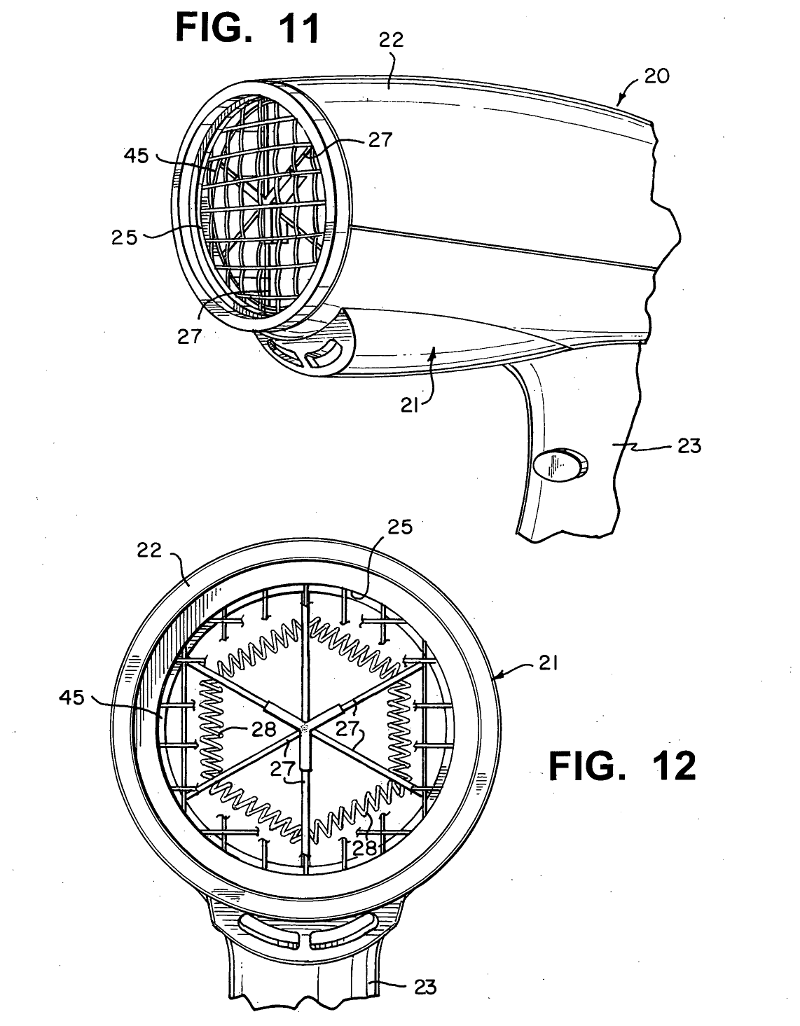

In FIGS. 11 and 12, a still further alternate embodiment of hair dryer 20 of the present invention is depicted. In this embodiment, as with the embodiments detailed above, hair dryer 20 comprises housing 21 which incorporates elongated, generally cylindrical, tubular shaped body portion 22 which is connected with handle portion 23. In addition, body portion 22 incorporates an inlet portal (not shown) and an exit portal 25.

As is evident from the foregoing detailed discussion, hair dryer 20 depicted in FIGS. 9-12 is constructed in a manner substantially identical to the construction detailed above in reference to FIGS. 1 and 2. As a result, numerical references are incorporated in FIGS. 9-12 which are identical to the numerical references detailed in FIGS. 1 and 2, with the associated disclosure thereof being incorporated herein by reference.

In this embodiment of the present invention, far-infrared/infrared radiation is generated and delivered to the heated air flow by mounting ceramic coated ring 45 in association with exit portal 25 of hair dryer 20. As depicted, in this embodiment, a substantially circular shaped ring member is employed, similar in construction to ring 40 of FIGS. 9 and 10. However, in this embodiment, the diameter of ring 45 is substantially greater than the diameter of ring 40, comprising a diameter slightly less than the diameter of exit portal 25.

Regardless of which construction is employed, it has been found that the desired far-infrared/infrared radiation is generated and delivered to the heated air flow by incorporating either ring 40 or ring 45 in hair dryer 20. Furthermore, if desired, the ceramic element mounted in association with exit portal 25 may comprise any desired size or shape. Consequently, it is to be understood that all alternative configurations are intended to be incorporated into the overall disclosure provided herein, as well as being encompassed by the scope of protection afforded to this invention.

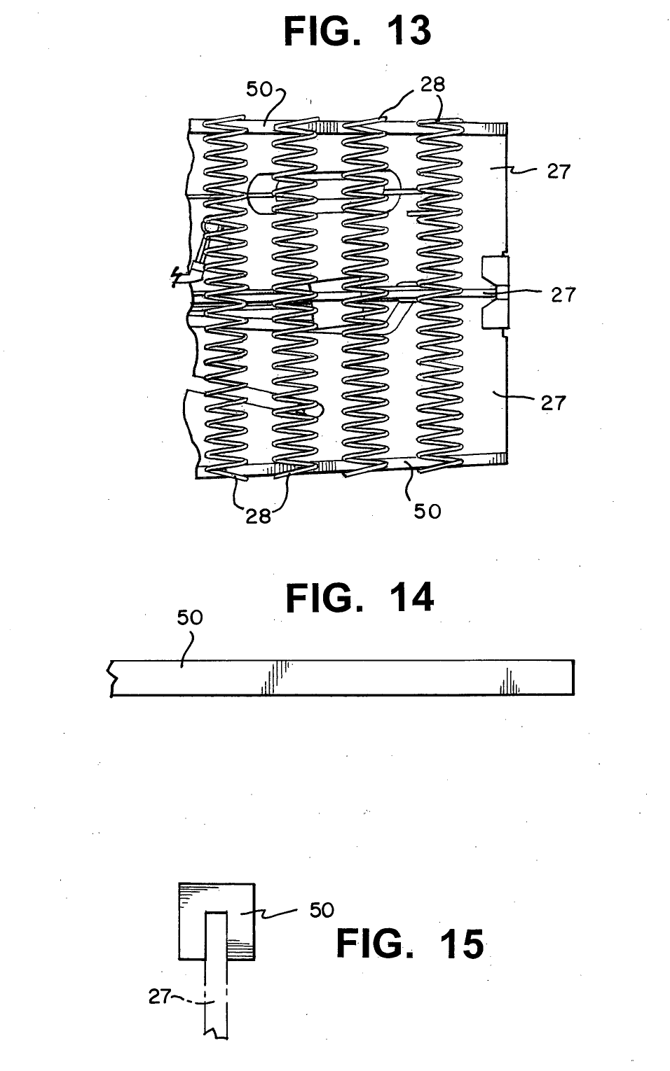

In FIGS. 13-15, a still further alternate embodiment of the present invention is depicted. In this embodiment, a hair dryer construction virtually identical to the overall construction detailed above and shown in FIGS. 1 and 2 is employed. Furthermore, in order to provide the desired far-infrared/infrared radiation and enable the radiation to be delivered to the heated airflow, ceramic elements 50 are employed.

As shown, in this embodiment, each ceramic element 50 comprises an elongated, longitudinally extending, generally rectangular shaped member formed entirely of ceramic material. In addition, ceramic element 50 comprises, in its preferred construction, a general U-shaped cross-section.

In order to employ this embodiment of the present invention, a plurality of ceramic elements 50 are individually mounted along a terminating edge of each support plate 27 used in establishing the heating element employed in the hair dryer. With ceramic elements 50 mounted along each of the terminating edges of each support plate 27, heating coil 28 is wrapped about support plates 27 and ceramic elements 50. In this way, ceramic elements 50 are mounted and held in cooperating relationship with heating coil 28, for enabling far-infrared/infrared radiation to be produced and delivered directly to the heated airflow passing through tubular shape body portion 22 of hair dryer 20.

As evident from the foregoing detailed discussion, by forming each ceramic element 50 with a substantially U-shape extending the entire length thereof, each ceramic element 50 is quickly and easily positioned directly along the edge of support plate 27, fully engaging support plate 27 for mounted engagement therewith. In this way, ceramic element 50 can be mounted in place quickly and easily.

Furthermore, any desired number of ceramic elements 50 can be employed in carrying out this embodiment of the present invention. In this regard, in a preferred construction, a separate ceramic element 50 is mounted along each exposed edge of each support plate 27. However, if desired, ceramic elements 50 may be mounted on some of the exposed edges of support plate 27, without being employed on every edge.

Furthermore, if desired, ceramic elements 50 may have a wide variety of sizes, shapes, or alternate configurations desired by the user. In addition, if desired, each ceramic element 50 may be mounted to support plate 27 with heating coil 28 wrapped around ceramic element 50, as depicted in FIG. 13, or constructed for overlying heating coil 28 after coil 28 has been wrapped on support plate 27. Regardless of the configuration or construction employed, the overall concept taught in FIGS. 13-15 may be employed in a wide variety of alternate configurations, all of which are intended to be within the scope of the present invention.

It will thus be seen that the objects set forth above, among those made apparent from the preceding description, are efficiently attained and, since certain changes may be made in the above constructions without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

1. A hair dryer assembly comprising:
A. a housing incorporating a handle portion and an elongated, hollow conduit affixed to the handle portion
B. an air inlet portal and an air outlet portal formed at opposed ends of the elongated conduit;
C. a fan assembly mounted in the conduit for drawing ambient air into the inlet portal of the conduit and driving the air through the conduit and out of the exit portal;
D. a heater assembly comprising:
a. a heater support member mounted in the conduit between the inlet portal and the outlet portal,
b. a heating wire wrapped about the support member and constructed for generating heat whenever activated by the receipt of electricity, and
c. a source of electricity controllably deliverable to the heating wire for providing to require electricity to generate heat from the wire whenever the electrical source is activated; and
E. at least one ceramic member
a. mounted to the hair dryer in cooperating association with the exit portal;
b. constructed for generating hair enhancing beneficial effects whenever the temperature thereof is elevated, and
c. positioned for delivering the hair enhancing effects into the air flow for enabling the beneficial effects to be carried in the air flow to the hair fibers.

2. The hair dryer assembly defined in claim 1, wherein said ceramic member is further defined as comprising ceramic material formed in a configuration comprising one selected from the group consisting of beads, rods, cylinders, hollow tubes, rings, elongated strips and brackets.

3. The hair dryer assembly defined in claim 2, wherein said ceramic member is formed by coating a base member with ceramic material.

4. The hair dryer assembly defined in claim 3, wherein said ceramic member is further defined as comprising a ring shape and said ceramic member is mounted in cooperating association with the exit portal of the hair dryer.

5. The hair dryer assembly defined in claim 4, wherein said base member is defined as comprising aluminum anodized with ceramic.

6. The hair dryer assembly defined in claim 5, wherein said ring is mounted to the terminating ends of the heat support member positioned adjacent the exit portal, and comprises a diameter ranging between about 25% and 75% of the diameter of the exit portal.

7. The hair dryer assembly defined in claim 5, wherein said ring is mounted directly adjacent the exit portal and comprises a diameter slightly less than the diameter of the exit portal.

8. The hair dryer assembly defined in claim 2, wherein the ceramic member is further defined as being formed entirely by ceramic material and comprising one selected from the group consisting of beads, rods, cylinders, hollow tubes, and elongated strips.

9. The hair dryer assembly defined in claim 8, wherein said ceramic member is further defined as being mounted in association with the heater assembly.

10. The hair dryer assembly defined in claim 9, wherein the heating wire is further defined as comprising an arcuately curved, continuous coil spring member and having spiral shaped convolutions, and said ceramic member is further defined as being mounted in association with the coil spring member forming the heating wire of the heater assembly.

11. The hair dryer assembly defined in claim 10, wherein said ceramic member is further defined as being peripherally surrounded and retained in the arcuately curved, spiral convolutions of the coil spring member.

12. The hair dryer assembly defined in claim 11, wherein a plurality of ceramic members are employed and the ceramic members are mounted in the coil spring member throughout the length of the heater assembly.

13. The hair dryer assembly defined in claim 11, wherein a plurality of ceramic members are employed and are mounted in the coil spring member portion closest to the exit portal.

14. The hair dryer assembly defined in claim 11, wherein said ceramic member comprises a diameter ranging between about 2.8 and 3.5 mm.

15. The hair dryer assembly defined in claim 14, wherein said ceramic element comprises a cylindrical shape having a total length ranging between about 3.5 and 4.5 mm.

16. The hair dryer assembly defined in claim 9, wherein said ceramic member is further defined as comprising a hollow tube and is mounted to the heating wire in peripheral surrounding engagement thereon.

17. The hair dryer assembly defined in claim 9, wherein said ceramic member is further defined as comprising an elongated strip and is mounted along at least one edge of the heat support member of the heater assembly.

18. The hair dryer assembly defined in claim 17, wherein said ceramic member comprises a generally U-shape, cross-sectional configuration for enabling the ceramic member to be mounted along the edge of the heater support member.
